(19) United States
(12) Patent Application Publication
(10) Pub. No.: US 2006/0026462 A1
(43) Pub. Date: Feb. 2, 2006

(54) Apparatus for recovering BIOS in computer system

(75) Inventors: Su-Shun Zhang, Shenzhen (CN); Ke Pu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/115,709

(22) Filed: Apr. 27, 2005

(30) Foreign Application Priority Data
Jul. 7, 2004 (CN) 200410028017.4

(51) Int. Cl. G06F 11/00

(52) U.S. Cl. 714/36

(57) ABSTRACT

A basic input-output system (BIOS) online burning system comprises a burning machine (100), a BIOS online burning card (200), a motherboard (300) and a corrupted BIOS (380) attached on the motherboard. The BIOS online burning card is connected between the burning machine and the corrupted BIOS. The BIOS online burning card comprises a serial communication circuit (220), a first buffer (272) working all the time, a second buffer (274), a third buffer (276), a single chip (260) controlling the working schedule to make the second buffer and the third buffer time-sharing work, a mother BIOS (280) and a connector (290) connected with the corrupted BIOS. The serial communication circuit is connected with the burning machine. The single chip, the first buffer, the mother BIOS and the third buffer together compose a loop. The single chip, the first buffer, the corrupted BIOS and the second buffer together compose another loop.

### BACKGROUND OF THE INVENTION

1. Field of the Invention

The present invention relates to a recovery apparatus, and more particularly to a BIOS recovery apparatus for recovering a basic input output system (BIOS) chip of a motherboard in a computer system.

2. Prior Art

The use of computers, especially personal computers (PCs) is widespread. The computing power of the PC, whether coupled to a network or operating as a stand-alone device, has increased significantly as new computer designs move into production. In view of the fact that many computer users are relatively unfamiliar with the technical aspects of computer operation, computer manufacturers have made a concerted effort to simplify operation of the computer. For example, many computer systems are pre-loaded with computer software so that a purchaser simply plugs the computer in and turns it on. In addition, software manufacturers have attempted to simplify the operating system itself.

However, there are still certain aspects of computer operation that baffle the typical user, and can cause significant difficulties even for the more experienced user. For example, when the computer is first powered up or reset, a software program, typically designated as a “basic input-output system” (BIOS) initializes the computer and permits the startup of an operating system, such as Microsoft MS-DOS.RTM. The BIOS program typically resides in a nonvolatile memory such as a read-only memory (ROM), an electrically programmable read only memory (EPROM), electrically erasable programmable nonvolatile memory (EEPROM) and flash memory devices (e.g., flash EEPROM). If the BIOS chip is defective for any reason, the computer will not function properly. Therefore, the BIOS chip is firstly needed to be detached from a motherboard through pyrogenation used by a special device. Then it is reattached to the motherboard after being reloaded updated BIOS from an updated disk. Typical example of this solution is disclosed in China Pat. No. 02204313.6. This operation is inconvenient and time consuming and likely to make the motherboard unused.

To overcome the shortcomings of the above-mentioned burning mode, an improved BIOS on line burning card to recover from a BIOS chip failure in a manner that does not require BIOS chip detached from the motherboard is needed.

### SUMMARY OF THE INVENTION

Accordingly, an object of the present invention is to provide a BIOS online burning card for updating a corrupted BIOS on a motherboard.

Accordingly, another object of the present invention is to provide a BIOS online burning system for recovering from a corrupted BIOS in a manner that does not require the corrupted BIOS detached from the motherboard.

To achieve the above-mentioned objects, a BIOS online burning system comprises a burning machine, a BIOS online burning card, a motherboard and a corrupted BIOS attached on the motherboard. The BIOS online burning card is connected between the burning machine and the corrupted BIOS. The BIOS online burning card comprises a serial communication circuit, a first buffer working all the time, a second buffer, a third buffer, a single chip controlling the working schedule to make the second buffer and the third buffer time-sharing work, a mother BIOS and a connector connected with the corrupted BIOS. The serial communication circuit is connected with the burning machine. The single chip, the first buffer, the mother BIOS and the third buffer together compose a loop. The single chip, the first buffer, the corrupted BIOS and the second buffer together compose another loop.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a block diagram of a BIOS online burning system in accordance with a preferred embodiment of the present invention;

FIG. 2 is a flow chart showing the operation principle of the BIOS online burning system of FIG. 1;

FIG. 3 is a block diagram of a BIOS online burning card in the BIOS online burning system;

FIG. 4 is a flow chart showing the operation of the BIOS online burning card of FIG. 3;

FIG. 5 is a block diagram showing the power-supply system of the BIOS online burning system of FIG. 1; and

FIGS. 6 and 7 a circuit diagram of the BIOS online burning card of FIG. 3.

### DETAILED DESCRIPTION OF THE INVENTION

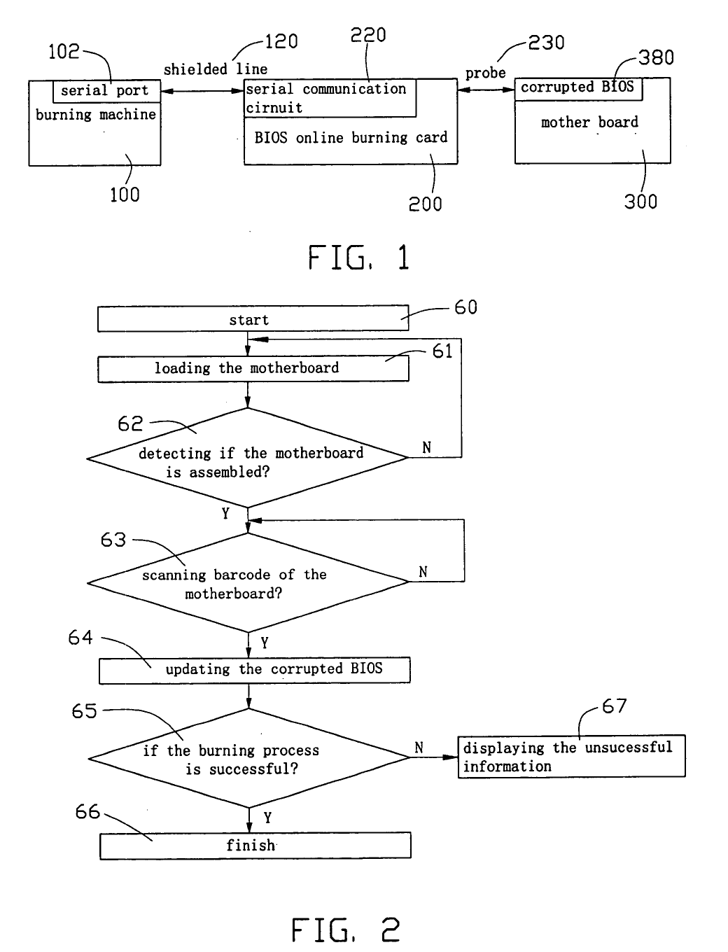

Referring to FIG. 1, a BIOS online burning system comprises a burning machine 100, a BIOS online burning card 200 used as a control interface and a motherboard 300 on which a corrupted BIOS is attached. The burning machine 100 is a personal computer and comprises a host computer and a display (not shown). The host computer comprises a burning platform on which the motherboard 300 is put. The display is used to implement a man-machine conversation. A shielded line 120 is connected between a serial port 102 of the burning machine 100 and a serial communication circuit 220 of the BIOS online burning card 200 to connect the burning machine 100 and the BIOS online burning card 200 together. The motherboard 300 is connected with the BIOS online burning card 200 via a plurality of probes 230.

Referring to FIG. 2, the burning process comprises following steps:

Step 60: starting up the burning machine 100, the burning machine 100 being initialized and displaying information about waiting for assembling the motherboard 300 thereon;

Step 61: putting the motherboard 300 on the burning platform of the burning machine 100;

Step 62: the probes 230 detecting if the motherboard 300 is assembled well, if it is, the burning process moving to the next step, if not, the process returns to the step 61;

Step 63: scanning a barcode of the motherboard 300, if it is scanned, the burning process moving to the next step, if not, repeating this step;

Step 64: displaying burning information, pressing a burning key on the burning machine 200 and the corrupted BIOS 380 begins to be updated online;

Step 65: the burning system detecting if the corrupted BIOS is successfully updated; Step 66: the BIOS program being detected in the corrupted BIOS to indicate the burning process is successful and the motherboard 300 is put off;

Step 67: the BIOS program not detected in the corrupted chip to indicate the burning process is unsuccessful and re-burning is needed.

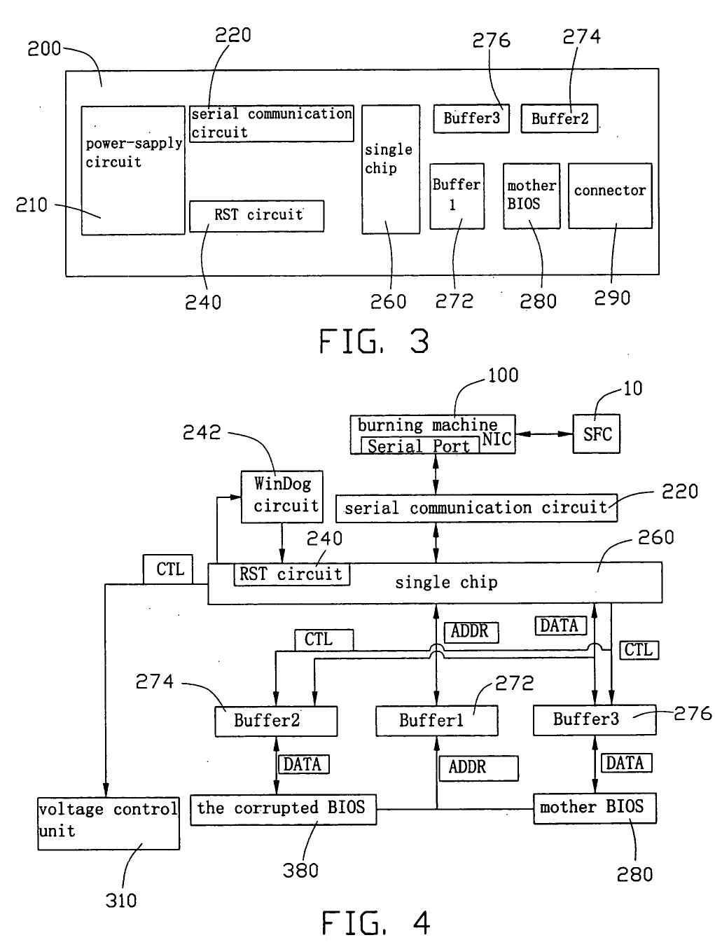

Referring to FIG. 3, showing modules that constitute the BIOS online burning card 200. The BIOS online burning card 200 comprises a power-supply circuit 210, a serial communication circuit 220, a reset (RST) circuit 240, a single chip 260, a first buffer 272, a second buffer 274, a third buffer 276, a mother BIOS 280 and a connector 290. The power-supply circuit 210 is connected to an outer power-supply that is provided by a motherboard power of the burning machine 100 for providing the needed voltage in the burning process. The serial communication circuit 220 is used to execute the communication between the BIOS online burning card 200 and the burning machine 100. The RST circuit 240 is connected with the single chip 260 for providing the hardware reset of the single chip 260.

Referring to FIG. 4, showing a block diagram of the working principle of the BIOS online burning card 200. The single chip 260 controls a voltage control unit 310 of the motherboard 300 via a voltage control signal. The single chip 260 is connected with the first buffer 272 through an address bus. The first buffer 272 is connected to the mother BIOS 280 and the corrupted BIOS 380 through an address bus for providing a routine through which the single chip 260 reads address data from the mother BIOS 280 and the corrupted BIOS 380. The single chip 260 is connected with the second buffer 274 and the third buffer 276 via a control bus and a data bus. The second buffer 274 is connected to the corrupted BIOS 380 through a data bus and the third buffer 276 is connected to the mother BIOS 280 through a data bus. Thus, the single chip 260, the first buffer 272 and the third buffer 276 together compose a loop. The single chip 260, the first buffer 272, the corrupted BIOS 380 and the second buffer 274 together compose another loop. The first buffer 272, the second buffer 274 and the third buffer 276 not only have a function of data buffer but also can change the signal voltage, that is, change the 5V voltage of the single chip 260 to a 3.3V voltage that is consistent with a working voltage of the BIOS. The first buffer 272 is in a working state all the time, and the second buffer 274 and the third buffer 276 are time-sharing shielded. When the third buffer 276 works, the second buffer 274 is shielded and the single chip 260 reads information of different address space from the mother BIOS 280. Then the second buffer 274 begins to work and the third buffer 276 is shielded, the single chip 260 writes the information in the mother BIOS 280 to corresponding address space of the corrupted BIOS 380.

In the burning process, the single chip 260 executes the hardware control through a windog circuit 242 to make the computer system reset from a RST circuit 240. The single chip 260 is connected to the burning machine 100 through the serial communication circuit 220 to implement the burning machine 100's controlling to the BIOS online burning card 200. The burning machine 100 is connected with a network interface card (NIC) through a soft control (SFC) system to implement the soft control.

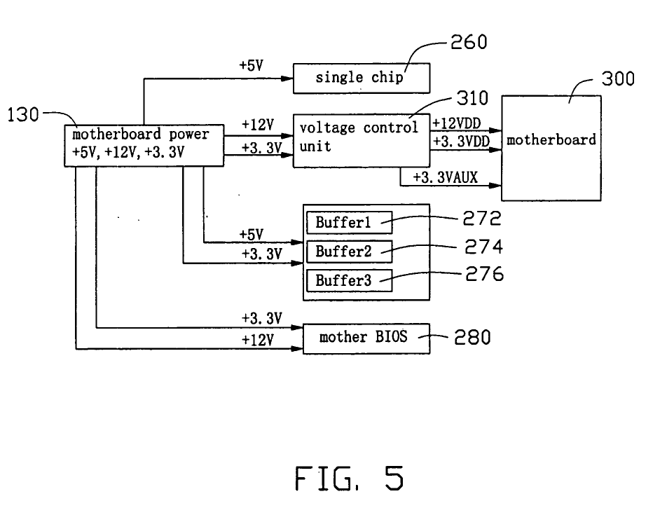

Referring to FIG. 5, a motherboard power 130 of the burning machine 100 provides the power source of the burning process. The single chip 260 is provided with 5V working voltage. The voltage control unit 310 is provided with two kinds of working voltages: +12V and +3.3V. The +12V voltage provides the corrupted BIOS 380 with quick updating and the +3.3V voltage provides a normal working voltage of the burning process. The voltage control unit 310 provides the motherboard 300 with three kinds of working voltages: +12 VDD, +3.3 VDD and +3.3 VAUX. Some circuits on the motherboard 300 should be shielded when in burning process and the +3.3 VAUX voltage is the needed shielding voltage. The motherboard power 130 also provides the first buffer 272, the second buffer 274 and the third buffer 276 each with two kinds of working voltages: +5V and +3.3V. The motherboard power 130 provides the mother BIOS 280 two kinds of working voltages: +12V and +3.3V. The +12V voltage is used for upgrading the mother BIOS chip 280 and the +3.3V voltage is the normal working voltage.

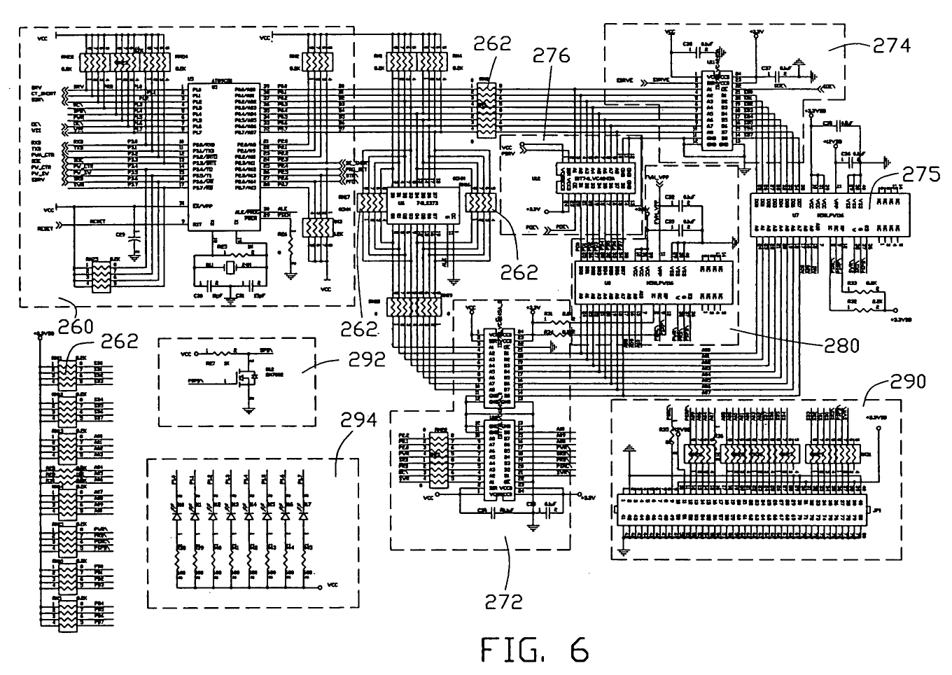

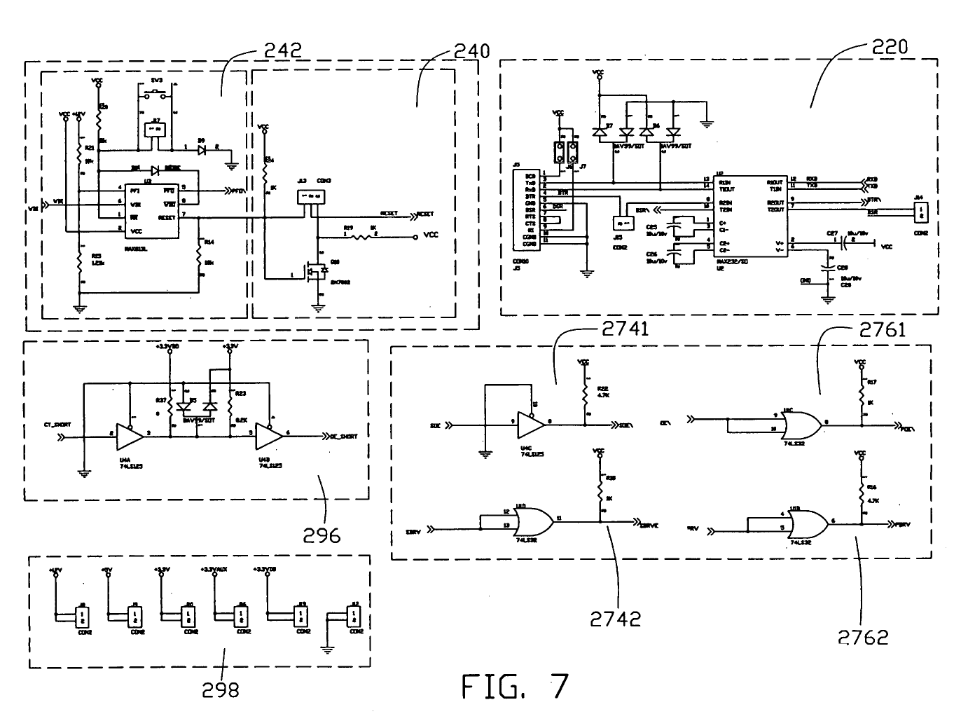

Referring to FIGS. 6 and 7, which show a preferred circuit diagram of the BIOS online burning card 200. In the preferred embodiment, the single chip 260 is constituted by an 8-bit microprocessor and is connected to the first buffer 272 through a flip-latch 74LS373. The flip-latch 74LS373 is shorted by a group of resistors 262 so it is not used in this burning process. Thus the single chip 260 is directly communicated with the first buffer 272. The circuit of the BIOS online burning card 200 comprises a lot of resistors such as the resistor 262 to short certain circuits as well as adjust the current in the circuit to improve drive ability. The single chip 260 is connected to the second buffer 274 and the third buffer 276 respectively through a group of resistors 262. The first buffer 272 and the third buffer 276 are directly connected to the mother BIOS 280 and the second buffer 274 maintains a pin that is to be connected to the corrupted BIOS 380. The mother BIOS 280 and the second buffer 274 can also be connected with a BIOS 275 that is offline for updating the BIOS 275. A control circuit 292 is connected with the single chip 260 for controlling input signals of the single chip 260. An indicating circuit 294 that comprises a plurality of lighting diodes is used to indicate the working state of the mother BIOS 280. Pins of a terminal of the connector 290 are connected to the first buffer 272 and the second buffer 274, and pins of an opposite terminal of the connector 290 are remained to be connected to the corrupted BIOS 380.

The windog circuit 242 comprises a MAX813L chip, one terminal of which is connected with a pin 8 of the single chip 260 and the other terminal is directly connected to a pin 9 of the single chip 260 to provide reset of the single chip 260. The serial communication circuit 220 is constituted by a MAX232 chip, a RXD pin and a TXD pin of which are connected with a pin 10 (P3.0/RXD) and a pin 11 (P3.1/TXD) respectively to provide the data communication between the burning machine 100 and the single chip 260. ADTR pin of the MAX232 chip is connected with a pin 26 (P2.5/A13) of the single chip 260 to control the data transferring time. A motherboard power testing circuit 296 comprises a plurality of diodes, a plurality of resistors and a plurality of arithmetic elements. The motherboard power testing circuit 296 tests if the motherboard 300 is shorted with ground so as to decide if the burning process is continued. A pin SOE of a controlling circuit 2741 and a pin SDRVE of a controlling circuit 2742 are connected with a pin 22 (OE) and a pin 2 (DIR) of the second buffer 274, respectively. A pin POE of a controlling circuit 2761 and a pin PDRVE of a controlling circuit 2762 are connected with a pin 23 (OE) and a pin 1 (DIR) of the third buffer 276. The BIOS online burning card 200 further comprises a connecting circuit 298, which is connected to a debugger, to debug the circuit of the BIOS online burning card 200.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A basic input-output system (BIOS) burning card for updating a corrupted BIOS on a motherboard comprising:
a power-supply circuit;
a first buffer working all the time;
a second buffer;
a third buffer,;
a single chip controlling a working schedule to make the second buffer and the third buffer time-sharing work;
a mother BIOS; and
a connector connected with the corrupted BIOS;
wherein the single chip, the first buffer, the mother BIOS and the third buffer together compose a loop, the single chip, the first buffer, the corrupted BIOS and the second buffer together compose another loop.

2. The BIOS burning card as described in claim 1, wherein the motherboard is connected with the BIOS online burning card via a plurality of probes.

3. The BIOS burning card as described in claim 1, wherein a voltage control unit is connected between the BIOS online burning card and the motherboard.

4. The BIOS burning card as described in claim 1, wherein the single chip executes a hardware control through a windog circuit to reset the computer system.

5. A basic input-output system (BIOS) online burning system comprising:
a burning machine;
a BIOS online burning card;
a motherboard; and
a corrupted BIOS attached on the motherboard;
wherein the BIOS online burning card is connected between the burning machine and the corrupted BIOS.

6. The BIOS online burning system as described in claim 5, wherein the BIOS online burning card comprises a serial communication circuit connected with the burning machine, a first buffer working all the time, a second buffer, a third buffer, a single chip controlling the working schedule to make the second buffer and the third buffer time-sharing work, a mother BIOS and a connector connected with the corrupted BIOS, wherein the single chip, the first buffer, the mother BIOS and the third buffer together compose a loop, the single chip, the first buffer, the corrupted BIOS and the second buffer together compose another loop.

7. The BIOS online burning system as described in claim 5, wherein the BIOS online burning card further comprises a RST circuit that is connected to the single chip.

8. The BIOS online burning system as described in claim 5, wherein the burning machine is a host computer.

9. The BIOS online burning system as described in claim 5, wherein the power of the BIOS online burning card and the motherboard is provided by a motherboard power of the burning machine.

10. The BIOS online burning system as described in claim 9, wherein a voltage control unit is connected between the motherboard power and the motherboard.

11. The BIOS online burning system as described in claim 5, wherein the motherboard is connected with the BIOS online burning card via a plurality of probes.

12. A method for updating content of a basic input-output system (BIOS) of a motherboard, comprising the steps of:
installing said motherboard to a burning machine;
electrically connecting said motherboard with said burning machine via a control interface;
retrieving a barcode of said motherboard from said motherboard;
updating said content of said BIOS of said motherboard via said burning machine under control of said control interface; and
verifying results of said updating step.

13. The method as described in claim 12, wherein said control interface defines two different control loops to retrieve information from said motherboard and said burning machine respectively and perform said updating step.

14. The method as described in claim 13, wherein at least one buffer of said control interface is commonly usable by said two control loops.
